(19) United States
(12) Patent Application Publication
(10) Pub. No.: US 2022/0091616 A1
(43) Pub. Date: Mar. 24, 2022

(54) AUTONOMOUS DRIVING METHOD, INTELLIGENT CONTROL DEVICE AND AUTONOMOUS DRIVING VEHICLE

(71) Applicant: Shenzhen Guo Dong Intelligent Drive Technologies Co., Ltd., Shenzhen (CN)

(72) Inventor: Jianxiong XIAO, Shenzhen (CN)

(73) Assignee: Shenzhen Guo Dong Intelligent Drive Technologies Co., Ltd, Shenzhen (CN)

(21) Appl. No.: 17/482,418

(22) Filed: Sep. 23, 2021

(30) Foreign Application Priority Data
Sep. 23, 2020 (CN) 202011021132.4

(51) Int. Cl. G05D 1/02; B60W 60/00

(52) U.S. Cl. CPC G05D 1/0274; B60W 60/001

(57) ABSTRACT

An autonomous driving method based on prior knowledge of high-precision maps is provided. The autonomous driving method includes steps of: acquiring a current location of the autonomous driving vehicle; acquiring a prior-knowledge set associated with the current location from a high-precision map; acquiring sensing information by one or more sensing devices; acquiring one or more pieces of the prior-knowledge associated with the sensing information from the prior-knowledge set; calculating a control instruction according to one or more pieces of the prior-knowledge; controlling the autonomous driving vehicle driving according to the control command. Furthermore, an intelligent control device and an autonomous driving device are also provided.

### CROSS REFERENCE TO RELATED APPLICATION

This non-provisional patent application claims priority under 35 U.S.C. § 119 from Chinese Patent Application No. 202011021132.4 filed on Sep. 23, 2020, the entire content of which is incorporated herein by reference.

### TECHNICAL FIELD

The disclosure relates to the field of autonomous driving technology, and in particular to an autonomous driving method, an intelligent control device and an autonomous driving vehicle.

### BACKGROUND

Nowadays, the maps (such as 3D high-definition map, 3D high-precision map, etc.) for autonomous driving vehicles generally include geometric map information for positioning, and semantic map information indicating road semantics. The semantic map information generally includes all road element information required for driving autonomous vehicles, such as descriptions of static objects on the road, descriptions of traffic lights, descriptions of lane lines and so on. The descriptions of the road elements, is represent definitely, that it is either black or white, such as “with lane”, “without lane”, “with traffic lights” or “without traffic lights”. According to the semantic map information, the autonomous driving vehicle can calculate the corresponding driving path, such as where to turn, where to stop, and which specific lanes to take in the driving path from point a to point B.

In the actual road conditions, in addition to the above semantic map information with fixed meaning, there are also some non fixed semantic map information. For example, some areas are default as parking areas, which have no actual parking signs and these parking areas are not labeled by the general semantic map information. Therefore, when the autonomous driving vehicle drives to the area, it needs to do a lot of calculation on environmental data provided by sensors to determine states of the autonomous driving vehicles in the areas, and then plan the optimal decision.

Therefore, when making planning decisions for the autonomous driving vehicles based on semantic map information, it often needs to spend a lot of computing power, and then delay the planning decision-making time, and the planning decision-making may not be accurate due to the long computing time.

### SUMMARY

The disclosure provides an autonomous driving method for an autonomous driving vehicle based on prior knowledge of high-precision maps, an intelligent control device, and an autonomous driving vehicle. The autonomous driving method can to calculate an optimal planning decision in a condition of less calculation and faster speed.

At a first aspect, the disclosure provides an autonomous driving method based on prior knowledge of high-precision maps, the autonomous driving method includes steps of: acquiring a current location of the autonomous driving vehicle; acquiring a prior-knowledge set associated with the current location from a high-precision map; acquiring sensing information by one or more sensing devices; acquiring one or more pieces of the prior-knowledge associated with the sensing information from the prior-knowledge set; calculating a control instruction according to one or more pieces of the prior-knowledge; controlling the autonomous driving vehicle driving according to the control command.

At a second aspect, the disclosure provides an intelligent control device, the intelligent control device includes a memory, and a processor. The memory is configured to store program instructions; the processor is configured to execute the program instructions to perform an autonomous driving method based on prior knowledge of high-precision maps, the autonomous driving method includes steps of: acquiring a current location of the autonomous driving vehicle; acquiring a prior-knowledge set associated with the current location from a high-precision map; acquiring sensing information by one or more sensing devices; acquiring one or more pieces of the prior-knowledge associated with the sensing information from the prior-knowledge set; calculating a control instruction according to one or more pieces of the prior-knowledge; controlling the autonomous driving vehicle driving according to the control command.

At a third aspect, the disclosure provides an autonomous driving vehicle, main body, and an intelligent control device installed the main body, the intelligent control device includes a memory, and a processor. The memory is configured to store program instructions; the processor is configured to execute the program instructions to perform an autonomous driving method based on prior knowledge of high-precision maps, the autonomous driving method includes steps of: acquiring a current location of the autonomous driving vehicle; acquiring a prior-knowledge set associated with the current location from a high-precision map; acquiring sensing information by one or more sensing devices; acquiring one or more pieces of the prior-knowledge associated with the sensing information from the prior-knowledge set; calculating a control instruction according to one or more pieces of the prior-knowledge; controlling the autonomous driving vehicle driving according to the control command.

The autonomous driving method provides one or more pieces of macro prior-knowledge about current environment surrounding the autonomous driving vehicle based on high-precision map, so that the autonomous driving vehicle can combine the prior-knowledge and real-time sensing information to obtain the optimal planning decision with less computing power and faster speed, which makes the autonomous driving safer and more convenient during driving.

### BRIEF DESCRIPTION OF THE DRAWINGS

In order to illustrate the technical solution in the embodiments of the disclosure or the prior art more clearly, a brief description of drawings required in the embodiments or the prior art is given below. Obviously, the drawings described below are only some of the embodiments of the disclosure. For ordinary technicians in this field, other drawings can be obtained according to the structures shown in these drawings without any creative effort.

FIG. 1 illustrates an autonomous driving method for an autonomous driving vehicle based on prior knowledge of high-precision maps in accordance with a first embodiment.

FIG. 2. illustrates a first sub flow chart diagram of the autonomous driving method in accordance with an embodiment.

FIG. 3. illustrates a flow chart diagram of the autonomous driving method in accordance with a second embodiment.

FIG. 4. illustrates a sub flow chart diagram of the autonomous driving method in accordance with the second embodiment.

FIG. 5a. illustrates a schematic diagram of a first scene at crossroads in accordance with an embodiment.

FIG. 5b. illustrates a schematic diagram of a second scene at crossroads in accordance with an embodiment.

FIG. 6. illustrates a second sub flow chart diagram of the autonomous driving method in accordance with the first embodiment.

FIG. 7. illustrates a part of a flow chart diagram of an autonomous driving method in accordance with a third embodiment.

FIG. 8. illustrates a sub flow chart diagram of an autonomous driving method in accordance with the first embodiment.

FIG. 9. illustrates a function block diagram of intelligent control device in accordance with the first embodiment.

FIG. 10. illustrates an autonomous driving vehicle in accordance with the first embodiment.

FIG. 11. illustrates a schematic diagram of a scene in which the autonomous driving vehicle drives in accordance with an embodiment.

### DETAILED DESCRIPTION OF THE EMBODIMENTS

In order to make the purpose, technical solution and advantages of the disclosure more clearly, the disclosure is further described in detail in combination with the drawings and embodiments. It is understood that the specific embodiments described herein are used only to explain the disclosure and are not used to define it. On the basis of the embodiments in the disclosure, all other embodiments obtained by ordinary technicians in this field without any creative effort are covered by the protection of the disclosure.

The terms “first”, “second”, “third”, “fourth”, if any, in the specification , claims and drawings of this application are used to distinguish similar objects and need not be used to describe any particular order or sequence of priority. It should be understood that the data used here are interchangeable where appropriate, in other words, the embodiments described can be implemented in order other than what is illustrated or described here. In addition, the terms “include” and “have” and any variation of them, can encompass other things. For example, processes, methods, systems, products, or device that comprise a series of steps or units need not be limited to those clearly listed, but may include other steps or units that are not clearly listed or are inherent to these processes, methods, systems, products, or device.

It is to be noted that the references to “first”, “second”, etc. in the disclosure are for descriptive purpose only and neither be construed or implied the relative importance nor indicated as implying the number of technical features. Thus, feature defined as “first” or “second” can explicitly or implicitly include one or more such features. In addition, technical solutions between embodiments may be integrated, but only on the basis that they can be implemented by ordinary technicians in this field. When the combination of technical solutions is contradictory or impossible to be realized, such combination of technical solutions shall be deemed to be non-existent and not within the scope of protection required by the disclosure.

Prior-knowledge of high-precision maps is stored in high-precision map. The prior-knowledge of high-precision map has certain significance for decision-making and planning of autonomous driving vehicles. The prior-knowledge in high-precision maps is associated with semantic map information in high-precision maps. The semantic map information is deterministic, and the prior-knowledge associated with semantic map information is not 100% deterministic, but the prior-knowledge can often provide guidance for autonomous driving vehicles.

The sources of prior-knowledge include but are not limited to the following four kinds: (1) Road test data of the autonomous driving vehicles; (2) Road test data obtained by human drivers driving the autonomous driving vehicles; (3) Location data of ordinary vehicles or mobile phones; (4) ADAS (advanced driving assistance system) auxiliary driving data. The ADAS uses a variety of sensors (millimeter wave radar, lidar, monocular/binocular camera and satellite navigation) installed in the car to sense the surrounding environment at any time during the car driving, collect data, identify, detect and track static and dynamic objects, compute and analysis systematically combining the sensing data with the navigator map data, so as to make the driver aware of the possible danger in advance, and effectively increase the car driving comfort and safety. The prior-knowledge is a large amount of statistical information, including but not limited to the above four kinds of data.

Referring to FIG. 1, FIG. 1 illustrates a flow chart diagram of the autonomous driving method based on prior knowledge of high-precision maps for an autonomous driving vehicle in accordance with the first embodiment. The autonomous driving method for an autonomous driving vehicle based on prior knowledge of high-precision maps includes the following steps.

In the step S101, a current location of the autonomous driving vehicle is acquired. In detail, the current location of the autonomous driving vehicle is obtained by GPS (Global Position System) or GNSS (Global Navigation Satellite System). the current location of the autonomous driving vehicle in the high-precision map is further to be confirmed according to sensing data of the current environment obtained by the senor installed on the autonomous driving vehicle. In some embodiments, a specific location of the autonomous driving vehicle in the high-precision map is determined by matching point cloud data obtained by lidar with built three-dimensional information in the high-precision map.

In the step S102, a prior-knowledge set associated with the current location is acquired from a high-precision map. In addition to the semantic information and geometric information of the high-precision map, the high-precision map also includes prior-knowledge associated with locations in the high-precision map. Specifically, the prior-knowledge is associated with an object at a certain location in a high-precision map. For an example, the prior-knowledge is associated with a smart traffic light at a certain location. Accordingly, the prior-knowledge includes the flashing rules of the traffic light. For an example, the prior-knowledge is associated with a specified area around a certain location in a high-precision map, which is represented on the high-precision map by geometric shape and can allow parking without a parking sign. Accordingly, the prior-knowledge includes the information indicating that the specified area is a parking area. For another example, the prior-knowledge is associated with an area where there is no speed limit sign but the actual speed limit is needed. Accordingly, the prior-knowledge includes the information indicating the commonly used speed is 30 km/h. In some other example, the prior-knowledge includes the information of U-turn vehicles passing through the area where U-turn is needed; the prior-knowledge includes the information of pedestrians in an area without a zebra crossing but often with pedestrians passing through; the prior-knowledge is associated with the behavior of objects in a specified area around a certain location in high-precision map, for example, the behavior of pedestrians in a certain area; the prior-knowledge includes the information that pedestrians in the area do not cross the road according to the traffic rules. In some embodiments, the prior-knowledge is associated with road conditions around a certain location in the high-precision map. For example, the prior-knowledge includes road sections within a specified range of the location, which are often in traffic jam; road sections with frequent traffic accidents; road sections with frequent road construction; road sections with frequent dangerous driving of other vehicles; road sections with poor public security; road sections with frequent glass fragments and pebbles; road sections with frequent flooding, road sections with frequent traffic accidents; road sections with frequent dangerous driving of other vehicles; road sections with poor public security; road sections with frequent occurrence of glass fragments and pebbles Information about bumpy road section; bad air road section; unsightly scenery road section; dusty road section; power and fuel consumption road section; roadside parking road section, and so on. The prior-knowledge of the object, region, object in region and surrounding path associated with the current location is obtained when acquiring the current location. The prior-knowledge set includes one or more piece of prior-knowledge.

In the step S103, sensing information is acquired by one or more sensing devices. In detail, the one or more sensing devices are installed on the autonomous driving device and the one or more sensing devices includes a lidar for acquiring point cloud data, and a camera for acquiring image data. The lidar and/or camera are configured to sense the environment around the autonomous driving vehicle and obtain the environment data represented by point cloud data and/or image respectively. The sensing information includes the environmental data sensed by each sensing devices. In some other embodiment, the one or more sensing devices may be installed beside roads where the autonomous driving device can drive.

In the step S104, one or more pieces of the prior-knowledge associated with the sensing information is acquired from the prior-knowledge set. In detail, an object in the point cloud data and/or image data, an area in a specified range, an object in a specified range, and a path around the object are acquired as the one or more pieces of the prior-knowledge. For example, a smart traffic light, a designated area, vehicles parked in a designated area and a feasible path. The prior-knowledge such as the flashing rules of the intelligent traffic lights, the area is a parking area without parking signs, the vehicles in the area are parking vehicles, and the road section has a 90% probability of traffic jam between 18:00 and 20:00 can be obtained from the prior-knowledge set.

In the step S105, a control instruction is calculated according to one or more pieces of the prior-knowledge. In detail, the control command includes a longitudinal control, a transverse control, and a calibration table. The calibration table refers to a speed acceleration brake/throttle command calibration table. Specifically, an instruction of waiting for a specified length of time, and a driving path of the autonomous driving vehicle after meeting the red light are calculated according to the flashing rules of smart traffic lights, the area is a parking area without parking signs, the vehicles in the area are parking vehicles, and the road section has 90% probability of traffic jam at 18:00-20:00. The driving path avoids the parking area without parking signs mentioned in prior-knowledge and the congested road section in this period. The above-mentioned waiting time, driving path and sensing data are used to calculate the longitudinal control, the lateral control and the calibration table by one of the methods of proportional integral differential control (PID), linear quadratic regulator (LQR), and model predictive control (MPC).

In the step S106, controlling the autonomous driving vehicle driving according to the control command. In detail, the longitudinal control, the lateral control, and the calibration table are converted into steering wheel control quantity and throttle/brake command to control autonomous driving vehicle.

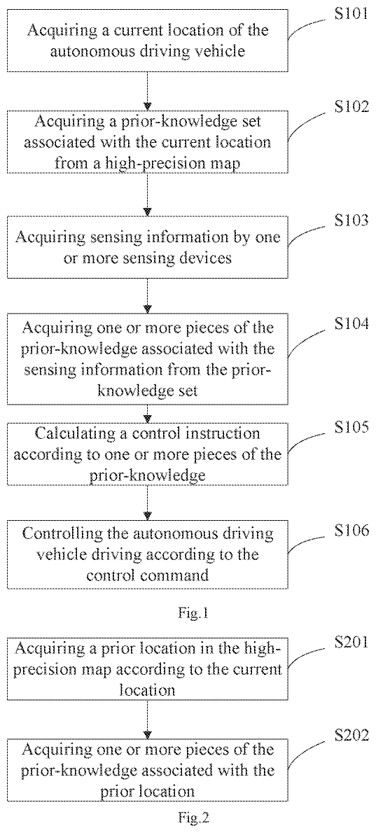

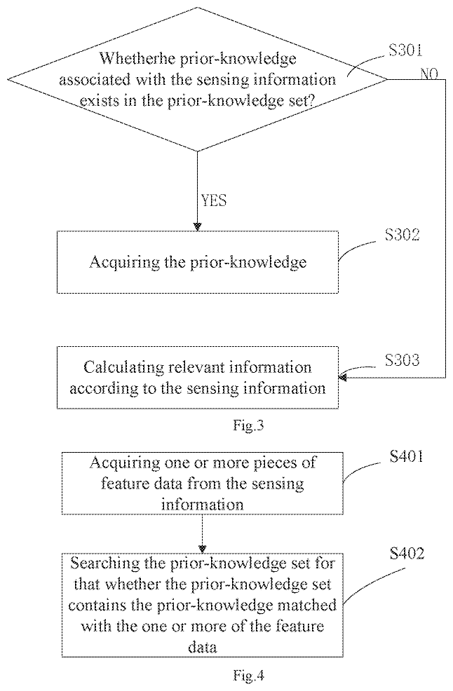

Referring to FIG. 2, FIG. 2 illustrates a first sub flow chart diagram of the autonomous driving method for the autonomous driving device based on the prior knowledge of high-precision maps in accordance with the first embodiment. The step S102 includes the following steps.

In the step S201, a prior location in the high-precision map is acquired according to the current location, and the high-precision map comprising several prior locations and one or more pieces of the prior-knowledge associated with each prior location. The prior location is a location where historical data is collected. The prior location does not coincide with the current location. Taking each prior location as the center, the high-precision map is divided into regions of the same size or different sizes according to a predetermined range. For example, when the current location located in a region of a prior location, the prior location corresponds to the current location. Using the current location to match the prior location in the high-precision map can confirm the prior location and one or more prior-knowledge associated with the prior location, which can save the computational power when the autonomous driving vehicle directly searches for one or more prior-knowledge.

In the step S202, one or more pieces of the prior-knowledge associated with the prior location is acquired, and the prior-knowledge set consists of one or more pieces of prior-knowledge. In detail, it is to acquire the prior-knowledge collected in the prior location, and the prior-knowledge associated with objects located in the current location, a region, objects in the region or in surrounding path of the regions. Furthermore, the prior-knowledge related to the intelligent traffic light flashing rules of the location, an area where there is no speed limit sign but the speed limit is needed, the common speed of passing through the area is 30 km/h, and branch roads on the left of the location being often blocked. The plurality of prior-knowledge constitutes the prior-knowledge set of the current location.

Referring to FIG. 3, FIG. 3 illustrates a flow chart diagram of the autonomous driving method based on the prior knowledge of high-precision maps in accordance with a second embodiment. The difference between the autonomous driving method based on prior knowledge of high-precision maps in accordance with the second embodiment and the autonomous driving method based on prior knowledge of high-precision maps in accordance with the first embodiment is that, the autonomous driving method based on prior knowledge of high-precision maps in accordance with the second embodiment includes following steps.

In the step S301, it is queried whether the prior-knowledge associated with the sensing information exists in the prior-knowledge set. In detail, it is queried whether there is prior-knowledge associated with the object identified in the point cloud data and/or image data, regions in the specified range, objects in the specified range and the surrounding path of the regions. Furthermore, the prior-knowledge indicates that whether there are intelligent traffic lights in the location, whether there are areas in the specified range, whether there are objects in the specified range and whether there are paths around the location.

In the step S302, if the prior-knowledge associated with the sensing information exists, the prior-knowledge is acquired. If there are intelligent traffic lights in the location, there are regions specified ranges accordingly, or objects in the regions and paths surrounding the regions, the prior-knowledge including the flashing rules of intelligent traffic lights in the location, a region of the location without speed limit sign but actually needs speed limit, the commonly used speed of 30 km/h passing through a region of the location, and the frequent traffic jam of the branch road on the left side of the location are obtained.

In the step S303, if the prior-knowledge associated with the sensing information does not exist, relevant information is calculated according to the sensing information. If there is no prior-knowledge associated with the intelligent traffic lights, the designated area, the object in the designated area or the surrounding path, corresponding missing information is calculated by the autonomous driving vehicle according to the sensing information.

Referring to FIG. 4, FIG. 4 illustrates a sub flow chart diagram of the step S301, the step S301 includes following steps.

In the step 5401, one or more piece of feature data is acquired from the sensing information. Objects can be identified from the point cloud data and/or image data, the area in the specified range, the object in the specified range and the surrounding path based on the feature information. Specifically, the intelligent traffic light feature data, such as shape data and color data, are calculated from the image data, which can be used to identify one or more piece of data of the intelligent traffic light.

In the step S402, the prior-knowledge set is searched for that whether the prior-knowledge set has prior-knowledge matched with the one or more pieces of the feature data. In addition to prior-knowledge, prior-knowledge set also includes prior feature information for identifying the prior-knowledge. It is understood that whether the prior-knowledge set has prior-knowledge matched with the one or more pieces of the feature data can be determined according to that whether the prior feature information has the one or more pieces of the feature data.

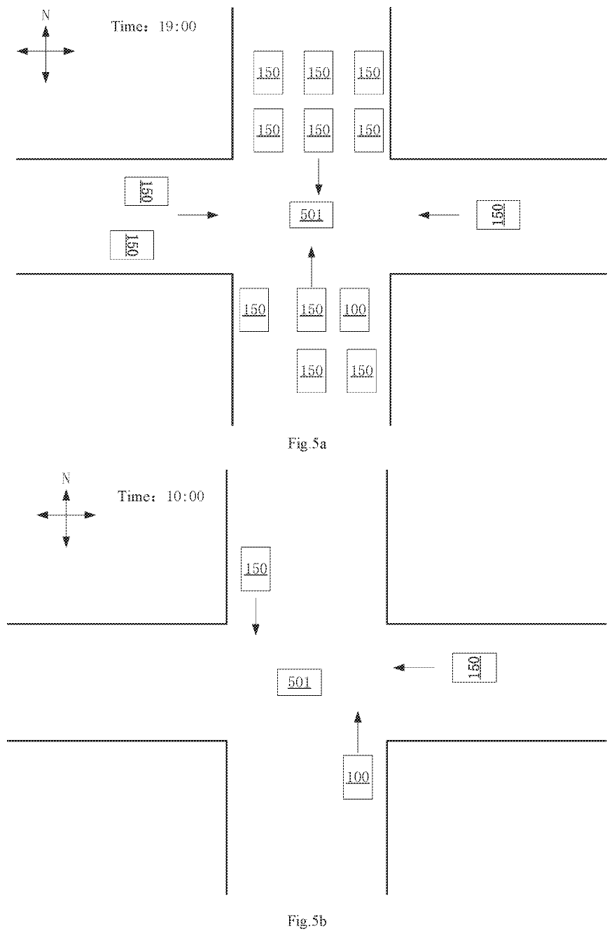

Referring to FIG. 5a and FIG. 5b, FIG. 5a and FIG. 5b illustrate a schematic diagram of different scenes at the same location in accordance with an embodiment. The prior-knowledge set also includes one or more scenes, and different scenes correspond to different prior-knowledge. For example, the scenes are divided according to time period that different time periods correspond to different scenes. In detail, a prior-knowledge set includes intelligent traffic lights 501. The prior-knowledge of intelligent traffic lights 501 is divided into three scenes, such as an ordinary scene, a peak scene at the morning and the evening, and a night scene. It is understood that, the number of vehicles 150 driving on different scenes is different, and road conditions that the autonomous driving vehicle 100 facing are different. As shown in FIG. 5b, 9:00-17:00 and 20:00-24:00 are ordinary scenes, a lighting time of red light and green light in ordinary scenes is 45 seconds, in other words, the lighting time of red light and green light is fixed and changeless. As shown in FIG. 5a, 7:00-9:00 and 18:00-20:00 are the peak scene at the morning and the evening, the lighting time of the red light and green light last is not fixed. Nearly 90% probability, the lighting time of red light and green light in North-South lane is 90 seconds, and the lighting time of red light and green light in East-West lane is 60 seconds. In addition, 0:00-6:00 is the night scene. In the night scene, the red light and green light are off, and the yellow light is flashing all the time.

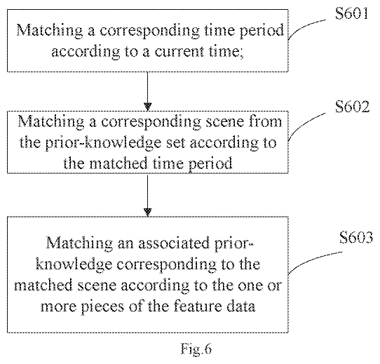

Referring to FIG. 6, FIG. 6 illustrates a sub-flow chart diagram of step S104 in accordance with an embodiment. The step S104 includes following steps.

In the step S601, a corresponding time period is matched according to the current time. Specifically, when the autonomous driving vehicle drives from the North-South lane to an intersection with intelligent traffic lights at 19:00 PM which belongs to the time period of 18:00-20:00, the. corresponding time period is 18:00-20:00.

In the step S602, a corresponding scene is matched from the prior-knowledge set according to the matched time period. For example, the corresponding time period is 18:00-20:00, and the peak scene at the morning and evening is selected.

In the step S603, an associated prior-knowledge corresponding to the matched scene is matched based on the one or more pieces of the feature data. For example, when the corresponding scene is the peak scene, the prior-knowledge of intelligent traffic lights in peak scene is obtained according to the shape data, color data and other feature information, such as, the prior-knowledge of intelligent traffic lights includes that the lighting time of the red light of the smart traffic light is 90 seconds.

The autonomous driving vehicle reduces the sampling frequency of the image sensor for sensing status of the traffic light, and reduces the amount of data processed by the autonomous driving vehicle based on the associated prior-knowledge. For example, if the autonomous driving vehicle stays at the intersection for more than 90 seconds, it is considered that there is a traffic jam at the intersection, and makes the autonomous driving vehicle enter in to a state of energy saving, and the computing power and energy consumption of the autonomous driving vehicle are saved.

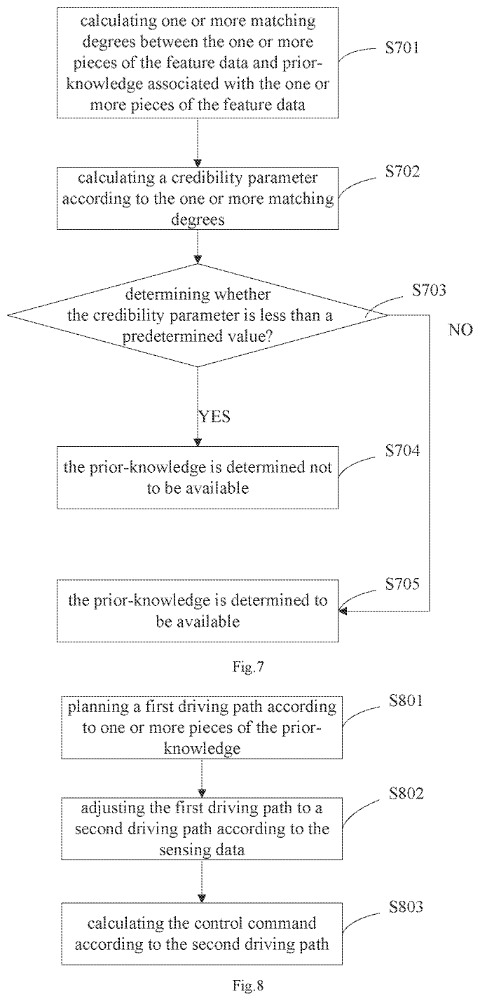

Referring to FIG. 7. FIG. 7 illustrates a part of a flow chart diagram of the autonomous driving method based on prior knowledge of high-precision maps in accordance with the third embodiment. The difference between the autonomous driving method based on prior knowledge of high-precision maps in accordance with the third embodiment and the autonomous driving method based on prior knowledge of high-precision maps in accordance with the first embodiment is that, the autonomous driving method based on prior knowledge of high-precision maps provided in accordance with third embodiment includes the following steps.

In the step S701, one or more matching degrees are calculated between one or more pieces of the feature data and associated prior-knowledge respectively. There are one or more matching parameters between the feature information and the associated prior-knowledge, the one or more matching parameters are used to calculate the matching degree. The matching parameters are environment parameters, when acquiring the prior-knowledge. For example, in a same location, the environment around the autonomous driving vehicle is different, and perceived behavior of the objects around the autonomous driving vehicle is different. Therefore, the prior-knowledge in the same environment with the driving autonomous device is precise to guiding the driving autonomous device. In detail, the environment parameters may be weather parameters, temperature parameters and humidity parameters and so on.

In the step S702, a credibility parameter is calculated according to the one or more matching degrees. In detail, the credibility parameter is calculated according to predetermined weights of the matching degrees of the environmental parameters, and each environmental parameter.

In the step S703, it is determined that whether the credibility parameter is less than a predetermined value. The predetermined value is a standard value of credibility, and is set in advance, and the calculated credibility parameter is compared with the standard value to determine that the credibility parameter is less than a predetermined value.

In the step S704, if the confidence parameter is greater than or equal to the predetermined value, it is determined that the prior-knowledge is available.

In the step S705, if the confidence parameter is less than the predetermined value, it is determined that the prior-knowledge is not available.

In the step S706, when the prior-knowledge is not available, the control instruction according to the sensing information is calculated.

The prior-knowledge of autonomous driving vehicles is determined to be available is or not that it is to ensure the safety of autonomous driving vehicles. Although the prior-knowledge is the information with high reliability, there are some errors in some extreme cases. In order to ensure the safety of autonomous driving vehicles, it is necessary to verify whether the prior-knowledge can be used in the current environment of the autonomous driving vehicle according to the credibility parameters before referring to the prior-knowledge. If the acquired prior-knowledge can be used in the current environment of the autonomous driving vehicle, it is necessary to make decision planning according to the prior-knowledge to save the computing power of the autonomous driving vehicle. If the acquired prior-knowledge can't be used in the current environment of the autonomous driving vehicles, decision-making planning is carried out according to the sensing data. As a result, it is capable of ensuring the safety and stability of autonomous driving vehicles.

Referring to FIG. 8, FIG. 8 illustrates a sub flow chart diagram of the step S105 in accordance with an embodiment. The step S105, includes following steps.

In the step S801, a first driving path according to the one or more pieces of the prior-knowledge is planned. In detail, the first driving path is planned according to the one or more pieces of the prior-knowledge such as the flashing rules of the intelligent traffic lights obtained from the prior-knowledge set, the commonly used speed of 30 km/h in the area, the area containing a parking area without parking signs, the parking vehicles in the parking area, and the road section having a 90% probability of traffic jam during 18:00 to 20:00.

Referring to FIG. 11, FIG. 11 illustrates a schematic diagram of a scene in the prior-knowledge applied to the autonomous driving vehicle in accordance with an embodiment. As shown in FIG. 11, a parking vehicle 110 stops in a parking area 120, and the autonomous driving vehicle 100 drives on the road with a road block 130. According to the prior-knowledge of the speed limit of 30 km/h in the parking area 120 provided by the prior-knowledge, the speed of the autonomous driving vehicle 100 is limited below 30 km/h, and the autonomous driving vehicle 100 will drive along a path away a certain distance from a right side of the road, and the path is the first driving path.

In the step S802, the first driving path is adjusted to a second driving path according to the sensing data. The autonomous driving vehicle adjusts the first driving path according to the road conditions and other objects in the sensing information to obtain a more accurate second driving path. In detail, when the autonomous driving vehicle 100 detects that there is a vehicle on the right side of the road, the area provided by the prior-knowledge is the parking area 120, so the predicted trajectory of the vehicle detected by the autonomous driving vehicle 100 in the parking area 120 is stationary, that is, the parking vehicle 110. The autonomous driving vehicle adjusts the distance between the autonomous driving vehicle and the right side of the road according to the sensed parking vehicle 110 to obtain the second path. As a result, the autonomous driving vehicle does not need to calculate the predicted trajectory of the autonomous driving vehicle during driving, which reduces the computational power of the autonomous driving vehicle.

In the step S803, the control command according to the second driving path is calculated. Specifically, the longitudinal control, lateral control and calibration table are calculated by one of proportional integral differential control (PID), linear quadratic regulator (LQR) and model predictive control (MPC) according to the second driving path.

Referring to FIG. 9, FIG. 9 illustrates an internal function block diagram of an intelligent control device 900 in accordance with an embodiment. The intelligent control device may be a tablet computer, a desktop computer, or a notebook computer. The intelligent control device 900 can be loaded with any intelligent operating system. The intelligent control device 900 includes a memory 901, a processor 902, and a bus 903. The memory 901 is configured to store program instructions. The processor 902 is configured to execute the program instructions to enable the intelligent control device to perform the autonomous driving method. The memory 901 includes at least one type of readable memory, and the readable memory includes a flash memory, a hard disk, a multimedia card, card-type memory (for example, SD or DX memory, etc.), a magnetic memory, a magnetic disk, optical disk, and the like. In some embodiments, the memory 901 may be an internal storage unit of the intelligent control device 900, such as a hard disk of the smart control device 900. The memory 901 may also be a storage device of the external intelligent control device 900 in other embodiments, such as a plug-in hard disk equipped on the smart control device 900, a smart memory card (Smart Media Card, SMC), and a secure digital (Secure Digital), SD) card, flash card (Flash Card), etc. Furthermore, the memory 901 may also include both an internal storage unit of the intelligent control device 900 and an external storage device. The memory 901 can be used not only to store application software and various data installed in the intelligent control device 900, but also to temporarily store data that has been output or will be output.

The bus 903 may be a peripheral component interconnect (PCI) bus or an extended industry standard architecture (EISA) bus or the like. The bus can be divided into address bus, data bus, control bus and so on. For ease of representation, only one thick line is used in FIG. 9, but it does not mean that there is only one bus or one type of bus.

Furthermore, the intelligent control device 900 may further include a display component 904. The display component 904 may be an LED (Light Emitting Diode, light emitting diode) display, a liquid crystal display, a touch liquid crystal display, an OLED (Organic Light-Emitting Diode, organic light emitting diode) touch device, and the like. The display component 904 can also be appropriately referred to as a display device or a display unit, which is used to display the information processed in the intelligent control device 900 and to display a visualized user interface.

Furthermore, the smart control device 900 may also include a communication component 905. The communication component 905 may optionally include a wired communication component and/or a wireless communication component (such as a Wi-Fi communication component, a Bluetooth communication component, etc.). A communication connection is established between the intelligent control device 900 and other intelligent control devices.

The processor 902 may be a central processing unit (Central Processing Unit, CPU), a controller, a micro controller, a microprocessor or other data processing chip. In some embodiments, and the processor 902 is used to execute the program instructions stored in the memory 901 or processing data.

It is understood that, FIG. 9 only shows the intelligent control device 900 with components 901-905 and performing the automatic driving method based on prior-knowledge of high-precision maps. Those skilled in the art can understand that the components shown in FIG. 9 are not imitations to the intelligent control device 900, and the intelligent control device may include fewer or more components, or some certain components are combined, or has a different component arrangement.

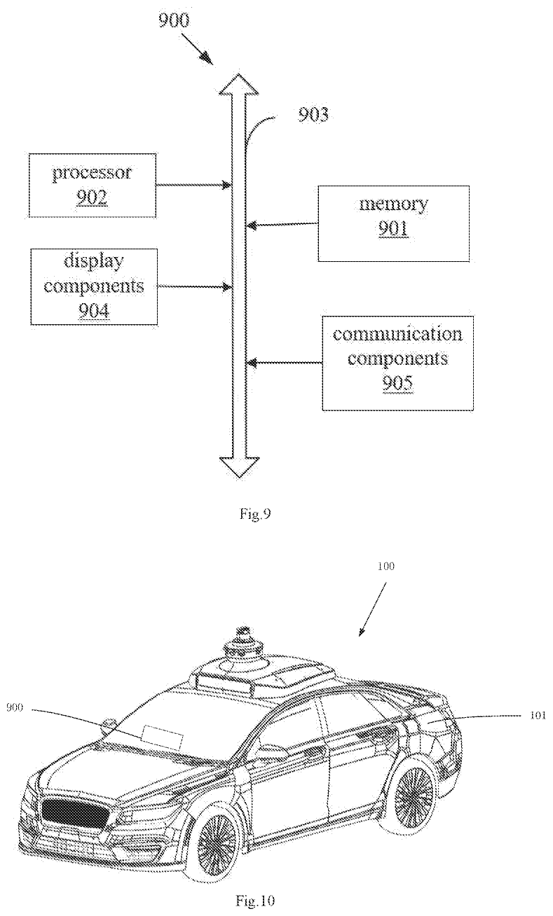

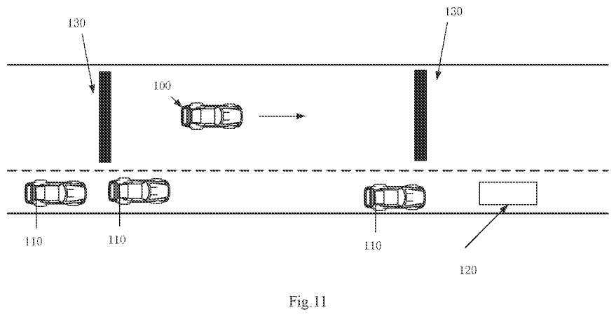

Referring to FIG. 10, FIG. 10 illustrates an autonomous driving vehicle in accordance with an embodiment. The automatic driving vehicle 100 includes a main body 101, and an intelligent control device 900 as described above. The intelligent control device 900 is mounted to the main body 101.

As described above, the automated driving vehicle is provided with one or more piece of macro prior-knowledge about the current environment based on the high-precision map, so that the automated driving vehicle can combine these instructive prior-knowledge and real-time sensing information that it can use less calculate optimal planning decisions with faster computing power to make the autonomous driving device driving safer and more convenient. The automatic driving method based on the prior-knowledge of high-precision maps greatly reduces the computing power of the automatic driving vehicle in predicting the behavior of obstacles. The driving decision-making plan of the automatic driving vehicle is planned based on the information in the prior-knowledge combined with the sensing information. As result, it can improve the autonomous driving device's responsiveness to the familiar environment, reduce the reaction time, improve the efficiency of path planning, and improve the experience and comfort of the occupants of the self-driving vehicle, so that autonomous driving device can serve people more efficiently and safely.

Obviously, those skilled in the art can make various changes and modifications to the present invention without departing from the spirit and scope of the present invention. In this way, if these modifications and variations of the present invention fall within the scope of the claims of the present invention and equivalent technologies, the present invention is also intended to include these modifications and variations.

The above are only the preferred embodiments of this disclosure and do not therefore limit the patent scope of this disclosure. And equivalent structure or equivalent process transformation made by the specification and the drawings of this disclosure, either directly or indirectly applied in other related technical fields, shall be similarly included in the patent protection scope of this disclosure.

1. An autonomous driving method for an autonomous driving vehicle based on prior knowledge of high-precision maps, the autonomous driving method comprising:
acquiring a current location of the autonomous driving vehicle;
acquiring a prior-knowledge set associated with the current location from a high-precision map;
acquiring sensing information by one or more sensing devices;
acquiring one or more pieces of the prior-knowledge associated with the sensing information from the prior-knowledge set;
calculating a control instruction according to one or more pieces of the prior-knowledge; and
controlling the autonomous driving vehicle driving according to the control command.

2. The autonomous driving method as claimed in claim 1, wherein acquiring a prior-knowledge set associated with the current location from the high-precision map further comprises:
acquiring a prior location in the high-precision map according to the current location, and the high-precision map comprising several prior locations and one or more pieces of the prior-knowledge associated with each prior location; and
acquiring one or more pieces of the prior-knowledge associated with the prior location, and the prior-knowledge set consisting of one or more pieces of prior-knowledge.

3. The autonomous driving method as claimed in claim 1, wherein before acquiring one or more pieces of the prior-knowledge associated with the sensing information from the prior-knowledge set further comprises:
querying whether the prior-knowledge associated with the sensing information exists in the prior-knowledge set;
if the prior-knowledge associated with the sensing information exists, acquiring the prior-knowledge; or
if the prior-knowledge associated with the sensing information does not exist, calculating relevant information according to the sensing information.

4. The autonomous driving method as claimed in claim 3, wherein querying whether the prior-knowledge associated with the sensing information exists in the prior-knowledge comprises:
acquiring one or more pieces of feature data from the sensing information; and
searching the prior-knowledge set for that whether the prior-knowledge set contains the prior-knowledge matched with the one or more pieces of the feature data.

5. The autonomous driving method as claimed in claim 4, wherein the prior-knowledge set further comprises one or more scenes, the scenes are divided according to time periods, different time periods correspond to different scenes respectively, and different scenes correspond to different prior-knowledge respectively.

6. The autonomous driving method as claimed in claim 5, wherein acquiring one or more pieces of the prior-knowledge associated with the sensing information from the prior-knowledge set comprises:
matching a corresponding time period according to a current time;
matching a corresponding scene from the prior-knowledge set according to the matched time period; and
matching an associated prior-knowledge corresponding to the matched scene according to the one or more pieces of the feature data.

7. The autonomous driving method as claimed in claim 6, wherein before calculating a control instruction according to one or more pieces of the prior-knowledge, the autonomous driving method based on prior knowledge of high-precision maps further comprises:
calculating one or more matching degrees between the one or more pieces of the feature data and prior-knowledge associated with the one or more pieces of the feature data;
calculating a credibility parameter according to the one or more matching degrees;
determining whether the credibility parameter is less than a predetermined value;
if the confidence parameter is greater than or equal to the predetermined value, the prior-knowledge is determined to be available; or
if the confidence parameter is less than the predetermined value, the prior-knowledge is determined not to be available; and
calculating the control instruction according to the sensing information.

8. The autonomous driving method as claimed in claim 7, wherein calculating a control instruction according to one or more pieces of the prior-knowledge further comprises:
planning a first driving path according to one or more pieces of the prior-knowledge;
adjusting the first driving path to a second driving path according to the sensing data; and
calculating the control command according to the second driving path.

9. An intelligent control device, the intelligent control device comprising:
a memory, configured to store program instructions;
a processor configured to execute the program instructions to perform an autonomous driving method for an autonomous driving device based on prior knowledge of high-precision maps, and the autonomous driving method based on prior knowledge of high-precision maps comprising:
acquiring a current location of the autonomous driving vehicle;
acquiring a prior-knowledge set associated with the current location from a high-precision map;
acquiring sensing information by one or more sensing devices;
acquiring one or more pieces of the prior-knowledge associated with the sensing information from the prior-knowledge set;
calculating a control instruction according to one or more pieces of the prior-knowledge; and
controlling the autonomous driving vehicle driving according to the control command.

10. The intelligent control device as claimed in claim 9, wherein acquiring a prior-knowledge set associated with the current location from the high-precision map further comprises:
acquiring a prior location in the high-precision map according to the current location, and the high-precision map comprising several prior locations and one or more pieces of the prior-knowledge associated with each prior location; and
acquiring one or more pieces of the prior-knowledge associated with the prior location, and the prior-knowledge set consisting of one or more pieces of prior-knowledge.

11. The intelligent control device as claimed in claim 9, wherein before acquiring one or more pieces of the prior-knowledge associated with the sensing information from the prior-knowledge set further comprises:
querying whether the prior-knowledge associated with the sensing information exists in the prior-knowledge set;
when the prior-knowledge associated with the sensing information exists, acquiring the prior-knowledge; or
when the prior-knowledge associated with the sensing information does not exist, calculating relevant information according to the sensing information.

12. The intelligent control device as claimed in claim 11, wherein querying whether the prior-knowledge associated with the sensing information exists in the prior-knowledge set, further comprises:
querying whether the prior-knowledge associated with the sensing information exists in the prior-knowledge set;
if the prior-knowledge associated with the sensing information exists, acquiring the prior-knowledge; or
if the prior-knowledge associated with the sensing information does not exist, calculating relevant information according to the sensing information.

13. An autonomous driving vehicle, the autonomous driving vehicle comprising:
main body, and
an intelligent control device installed the main body, the intelligent control device comprising:
a memory, configured to store program instructions of the autonomous driving method based on prior knowledge of high-precision maps;
a processor, configured to execute the program instructions to perform an autonomous driving method based on prior knowledge of high-precision maps, and the autonomous driving method based on prior knowledge of high-precision maps comprises:
acquiring a current location of the autonomous driving vehicle;
acquiring a prior-knowledge set associated with the current location from a high-precision map;
acquiring sensing information by one or more sensing devices;
acquiring one or more pieces of the prior-knowledge associated with the sensing information from the prior-knowledge set;
calculating a control instruction according to one or more pieces of the prior-knowledge; and
controlling the autonomous driving vehicle driving according to the control command.

14. The autonomous driving vehicle as claimed in claim 13, wherein acquiring a prior-knowledge set associated with the current location from the high-precision map further comprises:
acquiring a prior location in the high-precision map according to the current location, and the high-precision map comprising several prior locations and one or more pieces of the prior-knowledge associated with each prior location; and
acquiring one or more pieces of the prior-knowledge associated with the prior location, and the prior-knowledge set consisting of one or more pieces of prior-knowledge.

15. The autonomous driving vehicle as claimed in claim 13, wherein before acquiring one or more pieces of the prior-knowledge associated with the sensing information from the prior-knowledge set further comprises:
querying whether the prior-knowledge associated with the sensing information exists in the prior-knowledge set;
when the prior-knowledge associated with the sensing information exists, acquiring the prior-knowledge; or
when the prior-knowledge associated with the sensing information does not exist, calculating relevant information according to the sensing information.

16. The autonomous driving vehicle as claimed in claim 15, wherein querying whether the prior-knowledge associated with the sensing information exists in the prior-knowledge se comprises:
acquiring one or more pieces of feature data from the sensing information;
searching the prior-knowledge set for that whether the prior-knowledge set contains the prior-knowledge matched with the one or more pieces of the feature data.

17. The autonomous driving vehicle as claimed in claim 16, wherein the prior-knowledge set also comprises one or more scenes, the scenes are divided according to time periods, different time periods correspond to different scenes respectively, and different scenes correspond to different prior-knowledge respectively.

18. The autonomous driving vehicle as claimed in claim 17, wherein, acquiring one or more pieces of the prior-knowledge associated with the sensing information from the prior-knowledge set, further comprises:
wherein acquiring one or more pieces of the prior-knowledge associated with the sensing information from the prior-knowledge set comprises:
matching a corresponding time period according to a current time;
matching a corresponding scene from the prior-knowledge set according to the matched time period; and
matching an associated prior-knowledge corresponding to the matched scene according to the one or more pieces of the feature data.

19. The autonomous driving vehicle as claimed in claim 18, before calculating a control instruction according to one or more pieces of the prior-knowledge, the autonomous driving method based on prior knowledge of high-precision maps further comprises:
calculating one or more matching degrees between the one or more pieces of the feature data and prior-knowledge associated with the one or more pieces of the feature data;
calculating a credibility parameter according to the one or more matching degrees;
determining whether the credibility parameter is less than a predetermined value;
if the confidence parameter is greater than or equal to the predetermined value, the prior-knowledge is determined to be available; or
if the confidence parameter is less than the predetermined value, the prior-knowledge is determined not to be available; and
calculating the control instruction according to the sensing information.

20. The autonomous driving vehicle as claimed in claim 18, wherein calculating a control instruction according to one or more pieces of the prior-knowledge further comprises:
planning a first driving path according to one or more pieces of the prior-knowledge;
adjusting the first driving path to a second driving path according to the sensing data; and
calculating the control command according to the second driving path.
